(19) United States
(12) Patent Application Publication
(10) Pub. No.: US 2019/0095706 A1
(43) Pub. Date: Mar. 28, 2019

(54) IMAGE PROCESSING DEVICE AND PROGRAM

(71) Applicant: AISIN SEIKI KABUSHIKI KAISHA, Kariya-shi (JP)

(72) Inventors: Shingo FUJIMOTO, Anjo-shi (JP); Takuro OSHIDA, Tokai-shi (JP); Masao YAMANAKA, Tokyo-to (JP); Shintaro FUKUSHIMA, Tokyo-to (JP)

(73) Assignee: AISIN SEIKI KABUSHIKI KAISHA, Kariya-shi (JP)

(21) Appl. No.: 16/131,204

(22) Filed: Sep. 14, 2018

(30) Foreign Application Priority Data
Sep. 22, 2017 (JP) 2017-182748

(51) Int. Cl. G06K 9/00; G06K 9/62

(52) U.S. Cl. CPC G06K 9/00335; G06K 9/6226; G06K 9/00362; G06K 9/6232

(57) ABSTRACT

An image processing device includes: an extraction unit that performs a convolution processing and a pooling processing on information of an input image including an image of a person and extracts a feature from the input image to generate a plurality of feature maps; a first fully connected layer that outputs first fully connected information generated by connecting the plurality of feature maps; a second fully connected layer that connects the first fully connected information and outputs human body feature information indicating a predetermined feature of the person; and a third fully connected layer that connects the first fully connected information or the human body feature information to output behavior recognition information indicating a probability distribution of a plurality of predetermined behavior recognition labels.

### CROSS REFERENCE TO RELATED APPLICATIONS

This application is based on and claims priority under 35 U.S.C. § 119 to Japanese Patent Application 2017-182748, filed on Sep. 22, 2017, the entire contents of which are incorporated herein by reference.

### TECHNICAL FIELD

This disclosure relates to an image processing device and a program.

### BACKGROUND DISCUSSION

A device and a program for analyzing an image of a person and recognizing and outputting a behavior or the like of the person have been known.

Examples of related art are disclosed in JP-A-2010-036762 and JP-A-2012-033075.

However, the apparatus described above suffers from such a problem that only similar information having a small number of types can be output for acquired information.

Thus, a need exists for an image processing device and a program which are not susceptible to the drawback mentioned above.

### SUMMARY

An image processing device according to an aspect of this disclosure includes: an extraction unit that performs a convolution processing and a pooling processing on information of an input image including an image of a person and extracts a feature from the input image to generate a plurality of feature maps; a first fully connected layer that outputs first fully connected information generated by connecting the plurality of feature maps; a second fully connected layer that connects the first fully connected information and outputs human body feature information indicating a predetermined feature of the person; and a third fully connected layer that connects the first fully connected information or the human body feature information to output behavior recognition information indicating a probability distribution of a plurality of predetermined behavior recognition labels.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a diagram illustrating an overall configuration of an image processing system in which an image processing device of a first embodiment is installed.

FIG. 2 is a functional block diagram illustrating a function of a processing unit of the image processing device.

FIG. 3 is a flowchart of image processing to be executed by a processing unit of the image processing device.

FIG. 4 is a functional block diagram illustrating a function of a processing unit according to a second embodiment.

### DETAILED DESCRIPTION

The same components in the following exemplary embodiments are denoted by common reference numerals or symbols, and a redundant description will be appropriately omitted.

### First Embodiment

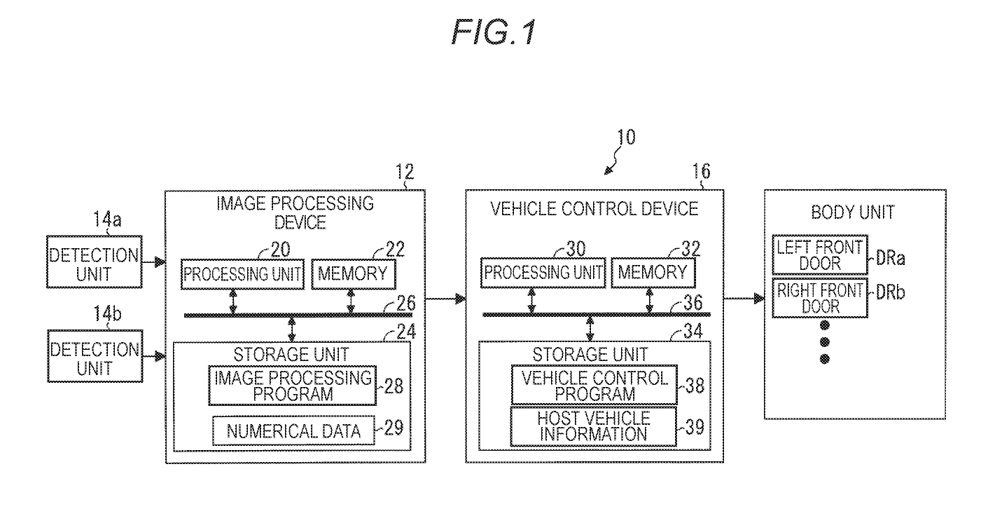

FIG. 1 is a diagram illustrating an overall configuration of an image processing system 10 in which an image processing device 12 of a first embodiment is installed. The image processing system 10 is mounted on, for example, a moving body such as an automobile having a driving source such as an engine or a motor. The image processing system 10 recognizes or predicts a feature of a body of an occupant of the automobile, a current behavior of the occupant, a future behavior of the occupant, or the like based on an image in a vehicle interior. The occupant of the automobile is an example of a person. As illustrated in FIG. 1, the image processing system 10 includes one or more detection units 14a and 14b, the image processing device 12, and a vehicle control device 16.

The detection units 14a and 14b detect and output information on the occupant in a vehicle interior of the automobile. For example, each of the detection units 14a and 14b is an imaging device that generates and outputs an image obtained by imaging the vehicle interior including the occupant as the information on the occupant and so on. More specifically, the detection unit 14a is an infrared camera that images a subject including the occupant with infrared rays to generate an infrared image. The detection unit 14b is a range sensor that generates a depth image including information on a distance to the subject including the occupant. The detection units 14a and 14b are connected to the image processing device 12 by LVDS (low voltage differential signaling), Ethernet (registered trademark) or the like so as to output the information to the image processing device 12. The detection units 14a and 14b output the information on the generated image to the image processing device 12.

The image processing device 12 recognizes the feature of the occupant's body and the current behavior of the occupant based on the image output by the detection units 14a and 14b, and predicts the future behavior of the occupant based on the recognition of the feature and the behavior. The image processing device 12 is a computer that includes an ECU (electronic control unit) or the like. The image processing device 12 is connected to the vehicle control device 16 by an LIN, a CAN or the like so as to output the information to the vehicle control device 16. The image processing device 12 includes a processing unit 20, a memory 22, a storage unit 24, and a bus 26.

The processing unit 20 is an arithmetic processing unit such as a hardware processor including a CPU (central processing unit) and a GPU (graphics processing unit) and the like. The processing unit 20 reads a program stored in the memory 22 or the storage unit 24 and executes processing. For example, the processing unit 20 executes an image processing program 28, to thereby generate information on a future behavior of the occupant predicted from the recognition of the feature and behavior of the occupant and output the generated information to the vehicle control device 16.

The memory 22 is a main storage device such as a ROM (read only memory) and a RAM (random access memory). The memory 22 temporarily stores various data to be used by the processing unit 20 at the time of execution of a program such as the image processing program 28.

The storage unit 24 is an auxiliary storage device such as a rewritable nonvolatile SSD (solid state drive) and an HDD (hard disk drive). The storage unit 24 maintains the stored data even in case where a power supply of the image processing device 12 is turned off. The storage unit 24 stores, for example, the image processing program 28 to be executed by the processing unit 20 and numerical data 29 including an activation function defined by a bias and a weight required for executing the image processing program 28.

The bus 26 connects the processing unit 20, the memory 22, and the storage unit 24 to each other so as to transmit and receive the information with respect to each other.

The vehicle control device 16 controls body units that are parts of the automobile including a left front door DRa, a right front door DRb, and the like based on the information on the feature of the occupant output by the image processing device 12, the recognized current behavior of the occupant, the predicted future behavior of the occupant, and so on. The vehicle control device 16 is a computer including an ECU and the like. The vehicle control device 16 may be integrated with the image processing device 12 by a single computer. The vehicle control device 16 includes a processing unit 30, a memory 32, a storage unit 34, and a bus 36.

The processing unit 30 is an arithmetic processing unit such as a hardware processor including a CPU and the like. The processing unit 30 reads the program stored in the memory 32 or the storage unit 34 and controls any of the body units. For example, upon acquiring a prediction result predicting the future behavior of the occupant that the occupant will open the door DRa or DRb from the image processing device 12, the processing unit 30 locks the door DRa or DRb to be predicted to open by the occupant so as not to open based on host vehicle information 39 (for example, information on approach to a moving body).

The memory 32 is a main storage device such as a ROM and a RAM. The memory 32 temporarily stores, for example, information on the future behavior or the like of the occupant acquired from the image processing device 12.

The storage unit 34 is an auxiliary storage device such as an SSD and an HDD. The storage unit 34 stores, for example, the vehicle control program 38 to be executed by the processing unit 30 and the host vehicle information 39 including information on the automobile.

The bus 36 connects the processing unit 30, the memory 32, and the storage unit 34 to each other so as to transmit and receive the information with respect to each other.

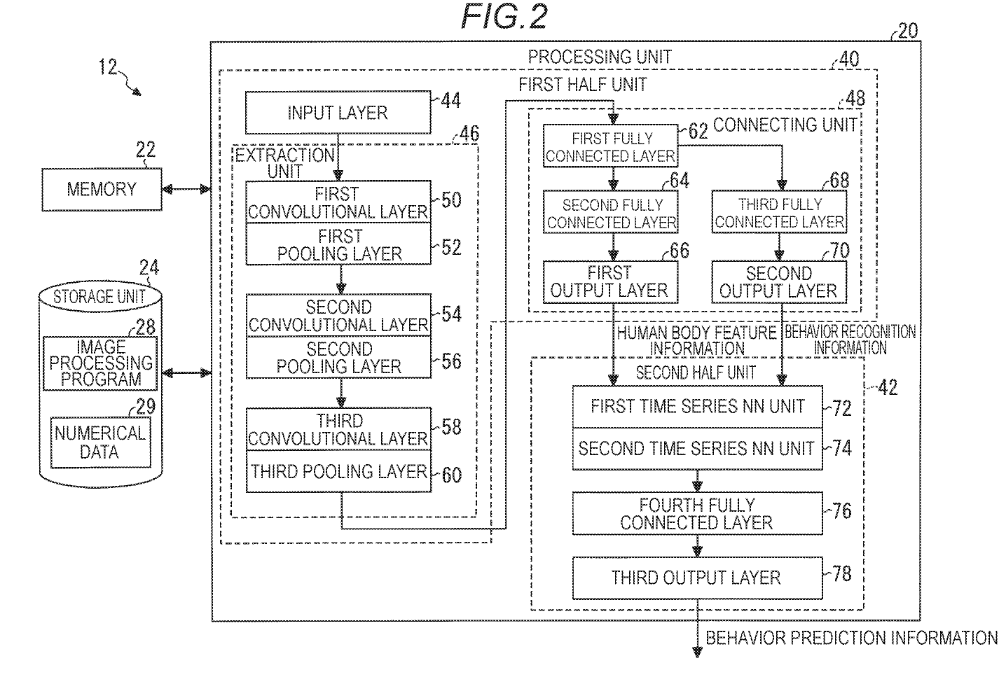

FIG. 2 is a functional block diagram illustrating a function of the processing unit 20 of the image processing device 12. As shown in FIG. 2, the processing unit 20 of the image processing device 12 includes a first half unit 40 and a second half unit 42 as an architecture. The processing unit 20 functions as the first half unit 40 and the second half unit 42, for example, by reading the image processing program 28 stored in the storage unit 24. Part or all of the first half unit 40 and the second half unit 42 may be configured by hardware such as a circuit including an ASIC (application specific integrated circuit) and an FPGA (field-programmable gate array) and the like.

The first half unit 40 analyzes one or multiple pieces of image information, generates the human body feature information and the behavior recognition information, and outputs the generated information to the second half unit 42. The first half unit 40 includes an input layer 44, an extraction unit 46, and a connecting unit 48.

The input layer 44 acquires information on one or multiple images (hereinafter referred to as input images) including the image of the occupant and outputs the acquired information to the extraction unit 46. The input layer 44 acquires, for example, an IR image captured by infrared rays, a depth image including distance information, and so on from the detection units 14a and 14b as input images.

The extraction unit 46 executes a convolution processing and a pooling processing on the information on the input images including the image of the occupant acquired from the input layer 44, extracts a predetermined feature from the input images, and generate multiple feature maps for generating human body feature information and behavior recognition information. The extraction unit 46 includes a first convolutional layer 50, a first pooling layer 52, a second convolutional layer 54, a second pooling layer 56, a third convolutional layer 58, and a third pooling layer 60. In other words, the extraction unit 46 includes three sets of convolutional layers 50, 54, 58 and pooling layers 52, 56, 60.

The first convolutional layer 50 has multiple filters (also referred to as neurons or units). Each of the filters is defined, for example, by an activation function including a bias value and a weight preset by machine learning with a teacher image. The bias value and the weight of each filter may be different from each other. The activation function may be stored in the storage unit 24 as a part of the numerical data 29. The same is applied to the bias value and the weight of the activation function described below. Each filter of the first convolutional layer 50 executes a first convolution processing by the activation function on all of the images acquired from the input layer 44. As a result, each filter of the first convolutional layer 50 generates an image (or the sum of images) in which the feature (for example, color shade) in the image are extracted based on the bias value and the weight as a feature map. The first convolutional layer 50 generates the feature maps of the same number as that of the filters and outputs the generated feature maps to the first pooling layer 52.

Each unit of the first pooling layer 52 performs a first pooling processing on the feature maps output by the first convolutional layer 50 with the use of a maximum pooling function, an average pooling function or the like. As a result, the first pooling layer 52 generates new feature maps of the same number as that of the units obtained by compressing or downsizing the feature maps generated by the first convolutional layer 50, and outputs the generated new feature maps to the second convolutional layer 54.

The second convolutional layer 54 has multiple filters defined by the activation function including a preset bias value and a preset weight. The bias value and the weight of the filters in the second convolutional layer 54 may be different from the bias value and the weight of the filters of the first convolutional layer 50. Each filter of the second convolutional layer 54 executes a second convolution processing by the activation function on the multiple feature maps output by the first pooling layer 52. As a result, each filter of the second convolutional layer 54 generates the sum of the images obtained by extracting the feature (for example, a horizontal edge) in an image different from that of the first convolutional layer 50 based on the bias value and the weight as the feature map. The second convolutional layer 54 generates the feature maps of the same number as that of the filters and outputs the generated feature maps to the second pooling layer 56.

Each unit of the second pooling layer 56 performs a second pooling processing on the feature maps output by the second convolutional layer 54 with the use of a maximum pooling function, an average pooling function or the like. As a result, the second pooling layer 56 generates new feature maps of the same number as that of the units obtained by compressing or downsizing the feature maps generated by the second convolutional layer 54, and outputs the generated new feature maps to the third convolutional layer 58.

The third convolutional layer 58 has multiple filters defined by the activation function including a preset bias value and a preset weight. The bias value and the weight of the filters in the third convolutional layer 58 may be different from the bias values and the weights of the first convolutional layer 50 and the second convolutional layer 54. Each filter of the third convolutional layer 58 executes a third convolution processing by the activation function on the multiple feature maps output by the second pooling layer 56. As a result, each filter of the third convolutional layer 58 generates the sum of the images obtained by extracting the feature (for example, a vertical edge) in an image different from that of the first convolutional layer 50 and the second convolutional layer 54 based on the bias value and the weight as the feature map. The third convolutional layer 58 generates the feature maps of the same number as that of the filters and outputs the generated feature maps to the third pooling layer 60.

Each unit of the third pooling layer 60 performs a third pooling processing on the feature maps output by the third convolutional layer 58 with the use of a maximum pooling function, an average pooling function or the like. As a result, the third pooling layer 60 generates new feature maps of the same number as that of the units obtained by compressing or downsizing the feature maps generated by the third convolutional layer 58, and outputs the generated new feature maps to the connecting unit 48.

The connecting unit 48 connects the feature maps acquired from the extraction unit 46 and outputs the human body feature information and the behavior recognition information to the second half unit 42. The connecting unit 48 includes a first fully connected layer 62, a second fully connected layer 64, a first output layer 66, a third fully connected layer 68, and a second output layer 70. The second fully connected layer 64 and the first output layer 66 are connected in parallel to the third fully connected layer 68 and the second output layer 70.

The first fully connected layer 62 includes multiple units (also referred to as neurons) defined by an activation function including a preset bias value and a preset weight. Each unit of the first fully connected layer 62 is connected to all of the units of the third pooling layer 60. Therefore, each unit of the first fully connected layer 62 acquires all of the feature maps output by all of the units of the third pooling layer 60. The bias value and the weight of the activation function of each unit of the first fully connected layer 62 are set in advance by machine learning or the like so as to generate first fully connected information for generating both of the human body feature information and the behavior recognition information. Each unit of the first fully connected layer 62 performs a first fully connecting processing based on the activation function on all of the feature maps acquired from the third pooling layer 60, to thereby generate the first fully connected information connecting the multiple feature maps together. Specifically, the first fully connected layer 62 generates a multidimensional vector for generating the human body feature information and the behavior recognition information as the first fully connected information. The number of dimensions of the vector of the first fully connected information output by the first fully connected layer 62 is set according to the human body feature information and the behavior recognition information of a subsequent stage, and is, for example, 27 dimensions. For example, the first fully connected information is the human body feature information indicating the feature of the occupant. The details of the human body feature information will be described later. Each unit of the first fully connected layer 62 outputs the generated first fully connected information to all of the units of the second fully connected layer 64 and all of units of the third fully connected layer 68. In other words, the first fully connected layer 62 outputs the same multiple pieces of first fully connected information to each of the second fully connected layer 64 and the third fully connected layer 68.

The second fully connected layer 64 includes multiple units (also referred to as neurons) defined by an activation function including a bias value and a weight. The number of units in the second fully connected layer 64 is the same as the dimension number of the human body feature information to be output. Each unit of the second fully connected layer 64 is connected to all of the units in the first fully connected layer 62. Therefore, each unit of the second fully connected layer 64 acquires the first fully connected information of the same number as the number of units in the first fully connected layer 62. The bias value and the weight of the activation function of the second fully connected layer 64 are set in advance with the use of machine learning or the like using a teacher image associated with the feature of the occupant so as to generate the human body feature information extracting multiple predetermined features of the occupant. The second fully connected layer 64 executes a second fully connecting processing based on the activation function on all of the first fully connected information acquired from the first fully connected layer 62, to thereby generate the human body feature information indicating the feature of the occupant by connecting the first fully connected information together, and output the generated human body feature information to the first output layer 66. For example, the second fully connected layer 64 may generate a multidimensional (for example, 27-dimensional) vector indicating the feature of the occupant as the human body feature information. More specifically, the second fully connected layer 64 may generate multiple (for example, twelve) two-dimensional vectors (24-dimensional vectors in total) indicating each position, weight, sitting height (or height), and so on of multiple portions and regions of the human body as the feature of the occupant, as a part of the human body feature information. In this example, the multiple portions of the human body include, for example, end points on the human body (upper and lower end portions of a face) and joints (a root of an arm, a root of a foot, an elbow, a wrist, and so on) and the like. In addition, the second fully connected layer 64 may generate a three-dimensional vector indicating an orientation of the occupant's face as a part of the human body feature information as the feature of the occupant. When the first fully connected information is the human body feature information, the second fully connected layer 64 outputs the human body feature information having higher accuracy than that of the first fully connected information. In that case, the second fully connected layer 64 may have the same configuration as that of the first fully connected layer 62. As described above, since the second fully connected layer 64 focuses on a human body portion as the feature of the occupant and generates the human body feature information from the first fully connected information which is the human body feature information in which the information other than the person information is reduced, the second fully connected layer 64 can generate the human body feature information that is less affected by noise (for example, behavior of the occupant) caused by an environmental change or the like.

With execution of a first output processing, the first output layer 66 narrows down the output of the second fully connected layer 64 to an output which is ultimately to be obtained as the output of the first output layer 66 or outputs the selected human body feature information to the second half unit 42.

The third fully connected layer 68 includes multiple units (also referred to as neurons) defined by an activation function including a preset bias value and a preset weight. The number of units in the third fully connected layer 68 is the same as the dimension number of the behavior recognition information to be output. Each unit of the third fully connected layer 68 is connected to all of the units in the first fully connected layer 62. Therefore, each unit of the third fully connected layer 68 acquires the first fully connected information of the same number as the number of units in the first fully connected layer 62. The bias value and the weight of the activation function of the third fully connected layer 68 are set in advance with the use of machine learning or the like using a teacher image associated with the behavior of the occupant so as to generate the behavior recognition information which is information on the current behavior of the occupant. The third fully connected layer 68 executes a third fully connecting processing based on the activation function on all of the first fully connected information acquired from the first fully connected layer 62, to thereby generate the behavior recognition information indicating a predetermined probability distribution of multiple behavior recognition labels by connecting the first fully connected information together, and output the generated behavior recognition information to the second output layer 70. The behavior recognition labels are, for example, labels given to the behavior of the occupant such as steering holding, console operation, opening and closing of the doors DRa and DRb, and the behavior recognition labels may be stored in the storage unit 24 as a part of the numerical data 29. For example, the third fully connected layer 68 may generate the behavior recognition information indicating a probability distribution indicating the probability of each of the multiple behavior recognition labels of the occupant with a multi-dimensional vector. The number of dimensions of the vector of the behavior recognition information is equal to the number of behavior recognition labels, for example, 11 dimensions. Each coordinate system of the multidimensional vectors of the behavior recognition information corresponds to any one of the behavior recognition labels, and the value of each coordinate system corresponds to the probability of the behavior recognition label. As described above, since the third fully connected layer 68 focuses on the behavior of the occupant and generates the behavior recognition information from the first fully connected information which is the human body feature information in which the information other than the person information is reduced, the third fully connected layer 68 can generate the behavior recognition information that is less affected by noise (for example, a state of a luggage surrounding the occupant and parts (sun visor or the like) of the automobile) caused by an environmental change or the like other than the human.

The second output layer 70 executes the second output processing, to thereby normalize the behavior recognition information acquired from the third fully connected layer 68 and output the normalized behavior recognition information to the second half unit 42.

The second half unit 42 generates the behavior prediction information on the future behavior of a target occupant (for example, several seconds later) from the multiple pieces of human body feature information and the multiple pieces of behavior recognition information different in time output by the first half unit 40, and outputs the information on the future behavior of the occupant to the vehicle control device 16. The second half unit 42 includes a first time series neural network unit (hereinafter referred to as a first time series NN unit) 72, a second time series neural network unit (hereinafter referred to as a second time series NN unit) 74, a fourth fully connected layer 76, and a third output layer 78.

The first time series NN unit 72 is a recurrent neural network having multiple (for example, 50) units. The unit of the first time series NN unit 72 is, for example, a GRU (gated recurrent unit) having a reset gate and an update gate and defined by a predetermined weight. Each unit of the first time series NN unit 72 acquires information (hereinafter referred to as “first unit output information”) output by a unit acquiring the human body feature information and the behavior recognition information of the multidimensional vector output by the first output layer 66 at a time t and the human body feature information and the behavior recognition information at a time t-Δt. Incidentally, Δt is a predetermined time, and is, for example, a time interval of an image acquired by the input layer 44. Each unit of the first time series NN unit 72 may acquire the past human body feature information and the past behavior recognition information (for example, at the time t-Δt) from the data previously stored in the memory 22 or the like. Each unit of the first time series NN unit 72 generates the first unit output information at the time t according to the human body feature information and the behavior recognition information at the time t and the first unit output information at the time t-Δt. Each unit of the first time series NN unit 72 outputs the generated first unit output information at the time t to a corresponding unit of the second time series NN unit 74 and also outputs the first unit output information to a corresponding unit of the first time series NN unit 72 acquiring the human body feature information and the behavior recognition information at the time t-Δt. In other words, the first time series NN unit 72 acquires multiple pieces of human body feature information different in time acquired from the first output layer 66 and acquires multiple pieces of behavior recognition information of the multidimensional vectors different in time from the second output layer 70. The first time series NN unit 72 generates, as first NN output information, information on the multidimensional vectors (for example, 50-dimensional vectors) having the multiple pieces of first unit output information generated according to the human body feature information and the behavior recognition information as elements by the first time series NN processing including the above-mentioned respective processes, and outputs the generated first NN output information to the second time series NN unit 74. The number of dimensions of the first NN output information is the same as the number of units.

The second time series NN unit 74 is a recurrent neural network having multiple (for example, 50) units. The number of units of the second time series NN unit 74 is the same as the number of units of the first time series NN unit 72. The unit of the second time series NN unit 74 is, for example, a GRU having a reset gate and an update gate and defined by a predetermined weight. Each unit of the second time series type NN unit 74 acquires the first unit output information which is the multidimensional vector output from the first time series NN unit 72 and the information (hereinafter referred to as “second unit output information”) output from a unit that has acquired the first unit output information at the time t-Δt. Each unit of the second time series NN unit 74 may acquire the past first unit output information (for example, at the time t-Δt) from the data stored in the memory 22 or the like in advance. Each unit of the second time series NN unit 74 generates the second unit output information at the time t according to the first unit output information at the time t and the second unit output information generated according to the first unit output information at the time t-Δt. Each unit of the second time series NN unit 74 outputs the generated second unit output information at the time t to all units of a fourth fully connected layer 76 to be described later, and also outputs the second unit output information to the unit of the second time series NN unit 74 acquiring the first unit output information at the time t-Δt. In other words, the second time series NN unit 74 acquires multiple pieces of first unit output information different in time output by each unit of the first time series NN unit 72. The second time series NN unit 74 generates, as second NN output information, information on the multidimensional vectors (for example, 50-dimensional vectors) having multiple pieces of second unit output information generated according to the multiple pieces of first unit output information as elements by a second time series NN processing having the above-mentioned respective processes to all the units of the fourth fully connected layer 76. The number of dimensions of the second NN output information is the same as the number of units and the number of dimensions of the first unit output information.

The fourth fully connected layer 76 has multiple units defined by an activation function including a preset bias value and a preset weight. Each unit of the fourth fully connected layer 76 acquires the second NN output information on the multidimensional vectors including all of the second unit output information output by each unit of the second time series NN unit 74. The fourth fully connected layer 76 generates the second fully connected information on the multidimensional vectors whose number of dimensions is increased by connecting the second NN output information together by a fourth fully connecting processing using the activation function, and outputs the generated second fully connected information to the third output layer 78. For example, when the second unit output information is a 50-dimensional vector, the fourth fully connected layer 76 generates the second fully connected information of 128-dimensional vectors.

The third output layer 78 has multiple units defined by the activation function including a preset bias value and a preset weight. The bias value and the weight of the activation function of the third output layer 78 are set in advance with the use of machine learning or the like using a teacher image associated with the behavior of the occupant so as to generate the behavior prediction information which is information on the future behavior of the occupant. The number of units is the same as the number (for example, 11) of behavior prediction labels indicating the behavior of the occupant to be predicted. In other words, each unit is associated with any one of the behavior prediction labels. The behavior prediction labels may be stored in the storage unit 24 as a part of the numerical data 29. Each unit of the third output layer 78 computes the second fully connected information acquired from the fourth fully connected layer 76 by the activation function, to thereby calculate the probability of the corresponding behavior prediction label. Incidentally, the multiple behavior recognition labels may not necessarily coincide with the multiple behavior prediction labels. Even with the configuration described above, the third output layer 78 of the second half unit 42 can predict the probability of the behavior prediction label not included in the multiple behavior recognition labels with the use of the behavior recognition information on the first half unit 40. The third output layer 78 may generate the probability distribution of the multiple behavior prediction labels in which the calculated probabilities are associated with the respective multiple behavior prediction labels as the behavior prediction information indicated by the multidimensional vectors. It should be noted that the third output layer 78 may normalize the probability of each behavior prediction label. Each coordinate system of the vectors of the behavior prediction information corresponds to any one of the behavior prediction labels, and the value of each coordinate system corresponds to the probability of the behavior prediction label. The number of dimensions of the behavior prediction information is the same as the number of behavior prediction labels and the number of units of the third output layer 78. Accordingly, when the number of units of the third output layer 78 is smaller than the number of dimensions of the second fully connected information, the number of dimensions of the behavior prediction information is smaller than the number of dimensions of the second fully connected information. The third output layer 78 selects the behavior prediction label having the highest probability from the generated behavior prediction information. The third output layer 78 outputs the behavior prediction label having the highest probability selected by the third output processing including the above-mentioned respective processes to the vehicle control device 16 or the like. It should be noted that the third output layer 78 may output the behavior prediction information generated by the third output processing including the above-mentioned respective processes to the vehicle control device 16 or the like.

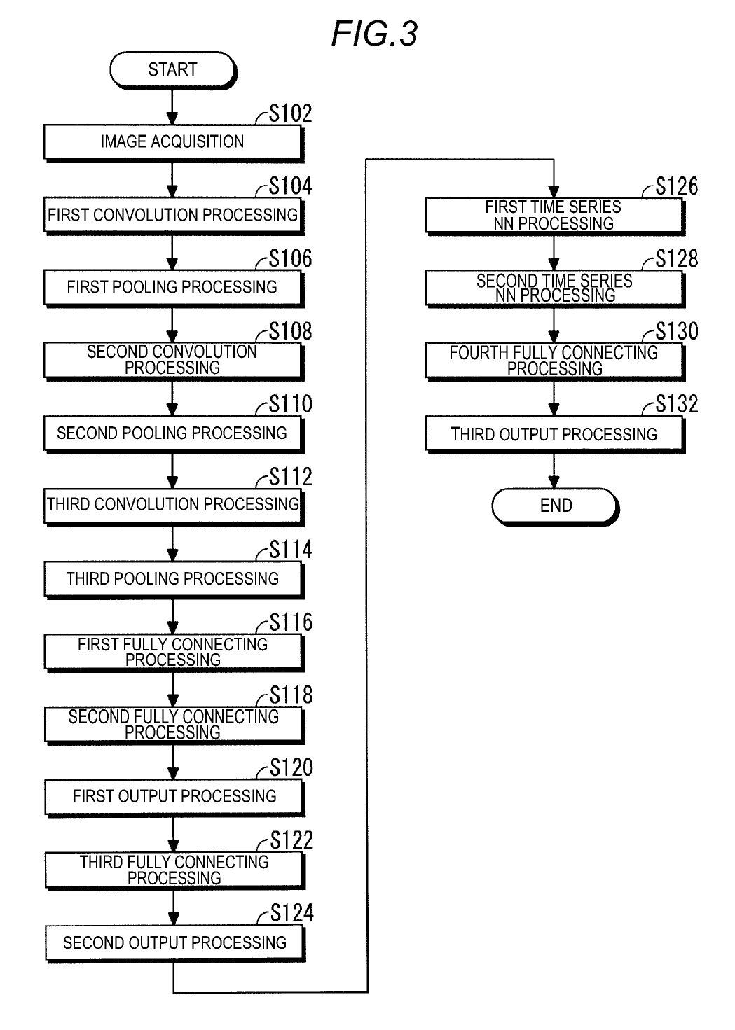

FIG. 3 is a flowchart of image processing to be executed by the processing unit 20 of the image processing device 12. The processing unit 20 reads the image processing program 28, to thereby execute image processing.

As shown in FIG. 3, in the image processing, the input layer 44 acquires one or multiple images and outputs the acquired images to each filter of the first convolutional layer 50 (S102). Each filter of the first convolutional layer 50 outputs the feature map generated by performing the first convolution processing on all of the images acquired from the input layer 44 to the corresponding unit of the first pooling layer 52 (S104). Each unit of the first pooling layer 52 outputs the feature map compressed and downsized by executing the first pooling processing on the feature map acquired from the first convolutional layer 50 to all of the filters of the second convolutional layer 54 (S106). Each unit of the second convolutional layer 54 executes the second convolution processing on all of the feature maps acquired from the first pooling layer 52 and generates a feature map in which a new feature has been extracted to output the generated feature map to a corresponding unit of the second pooling layer 56 (S108). Each unit of the second pooling layer 56 outputs the feature map compressed and downsized by executing the second pooling processing on the feature map acquired from the units of the second convolutional layer 54 to all of the filters of the third convolutional layer 58 (S110). Each unit of the third convolutional layer 58 executes the third convolution processing on all of the feature maps acquired from the second pooling layer 56 and generates a feature map in which a new feature has been extracted to output the generated feature map to a corresponding unit of the third pooling layer 60 (S112). Each unit of the third pooling layer 60 outputs the feature map compressed and downsized by executing the third pooling processing on the feature map acquired from the units of the third convolutional layer 58 to all of the units of the first fully connected layer 62 (S114).

Each unit of the first fully connected layer 62 generates the human body feature information obtained by connecting the feature map acquired from the third pooling layer 60 by the first fully connecting processing as the first fully connected information and outputs the generated first fully connected information to all of the units of the second fully connected layer 64 and all of the units of the third fully connected layer 68 (S116). Each unit of the second fully connected layer 64 executes the second fully connecting processing on all of the acquired first fully connected information to connect the first fully connected information together, thereby generating the human body feature information with enhanced accuracy and outputting the generated human body feature information to the first output layer 66 (S 118). The first output layer 66 outputs a new human body feature information generated by executing the first output processing on the human body feature information acquired from the second fully connected layer 64 to the first time series NN unit 72 (S120). Each unit of the third fully connected layer 68 executes the third fully connecting processing on all of the acquired first fully connected information to connect the first fully connected information together, thereby generating the behavior recognition information and outputting the generated behavior recognition information to the second output layer 70 (S 122). The second output layer 70 outputs a new behavior recognition information normalized by executing the second output processing on the behavior recognition information acquired from the third fully connected layer 68 to the first time series NN unit 72 (S124). Incidentally, Steps S118 and S120 and Steps S122 and S124 may be changed in order or may be executed in parallel.

Each unit of the first time series NN unit 72 executes the first time series NN processing on the multiple pieces of human body feature information and behavior recognition information different in time acquired from the first output layer 66 and the second output layer 70, and generates the first unit output information to output the generated first unit output information to the corresponding unit of the second time series NN unit 74 (S126). Each unit of the second time series NN unit 74 executes the second time series NN processing on the multiple pieces of first unit output information different in time acquired from the first time series NN unit 72, and generates the multiple pieces of second unit output information to output the generated second unit output information to all of the units of the fourth fully connected layer 76 (S128).

The fourth fully connected layer 76 outputs the second fully connected information generated by executing the fourth fully connecting processing on the second unit output information to the third output layer 78 (S130). The third output layer 78 outputs to the vehicle control device 16 the behavior prediction label having the highest probability selected from the behavior prediction information generated by executing the third output processing on the second fully connected information or the behavior prediction information (S132).

As described above, since the image processing device 12 according to the first embodiment generates and outputs two types of human body characteristic information and behavior recognition information different in quality from the first fully connected information generated from the information on the occupant's image, the image processing device 12 can output two types of information different in quality (that is, human body feature information and behavior recognition information) from one type of first fully connected information.

In the image processing device 12, the first fully connected layer 62 outputs the same first fully connected information to each of the second fully connected layer 64 and the third fully connected layer 68. In this manner, since the image processing device 12 generates the human body feature information and the behavior recognition information from the same first fully connected information, the image processing device 12 can output two types of information different in quality and reduce a time required for processing while suppressing complication of the configuration such as an architecture.

In the image processing device 12, the second half unit 42 generates the behavior prediction information from the multiple pieces of human body feature information and the multiple pieces of behavior recognition information different in time generated by the first half unit 40. In this manner, the image processing device 12 can generate the behavior prediction information together with the human body feature information and the behavior recognition information from the image by the configuration (architecture) mounted on one device. In addition, the image processing device 12 generates each information by one device, thereby being capable of tuning the bias, weight, and the like required for the behavior recognition and the behavior prediction together, and therefore the image processing device 12 can simplify the tuning work.

In the image processing device 12, the second half unit 42 generates the probability distribution of the multiple predetermined behavior prediction labels as the behavior prediction information. As a result, the image processing device 12 can predict and generate the probability of the multiple potential behaviors of the occupant.

In the image processing device 12, the second half unit 42 selects and outputs the behavior prediction label highest in probability from the behavior prediction information. As a result, the image processing device 12 can narrow down the future behaviors of the occupant to one behavior, thereby being capable of reducing a processing load of the vehicle control device 16 or the like which is an output destination.

In the image processing device 12, the first fully connected layer 62 outputs the human body feature information on the feature of the occupant generated by connecting the feature maps together as the first fully connected information to the second fully connected layer 64 and the third fully connected layer 68 at a subsequent stage. As a result, the second fully connected layer 64 can further improve the accuracy of the human body feature information. In addition, the third fully connected layer 68 can generate the behavior recognition information with high accuracy by reducing an influence of the environmental changes, such as the presence or absence of a luggage in a vehicle interior, which is information other than the person information. As a result, the second half unit 42 can generate and output more accurate behavior prediction information based on the more accurate human body feature information and behavior recognition information.

The image processing device 12 sets the bias and the weight of the activation function of the third fully connected layer 68, the third output layer 78, and so on in advance by machine learning using the teacher image associated with the behavior of the occupant. As a result, the image processing device 12 can perform the behavior recognition and the behavior prediction by associating the image with the behavior.

### Second Embodiment

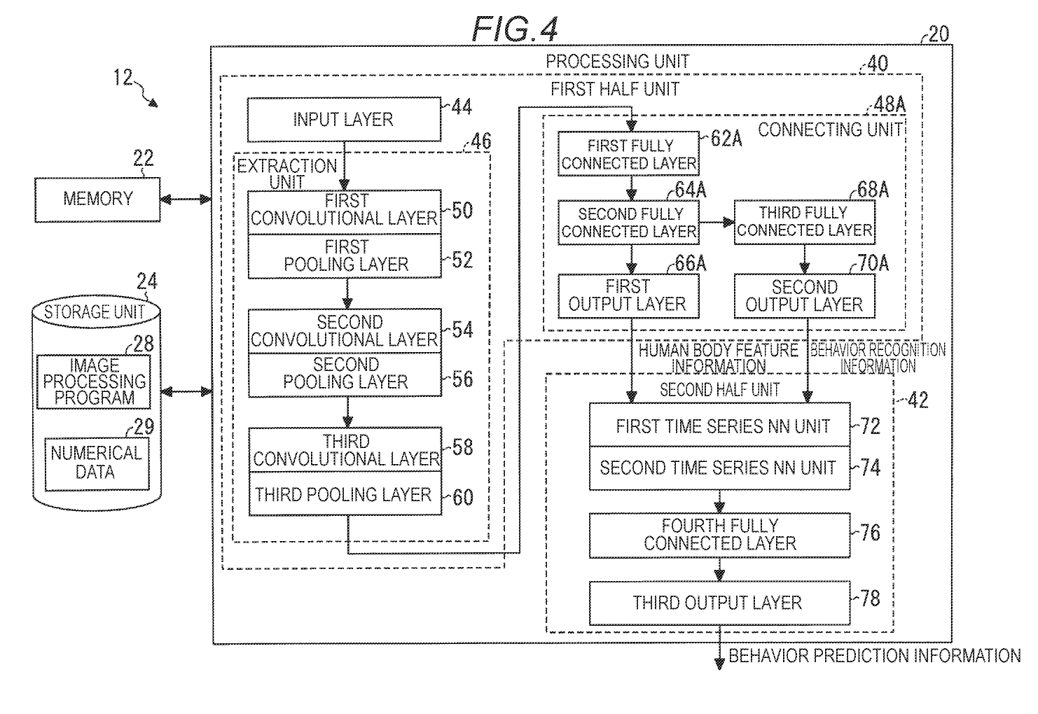

FIG. 4 is a functional block diagram illustrating a function of a processing unit 20 according to a second embodiment. The processing unit 20 of an image processing device 12 according to the second embodiment is different from the first embodiment in a configuration of a connecting unit 48A.

As shown in FIG. 4, the connecting unit 48 A of the second embodiment includes a first fully connected layer 62A, a second fully connected layer 64A, a first output layer 66A, a third fully connected layer 68A, and a second output layer 70A.

The first fully connected layer 62A outputs the human body feature information generated from the multiple feature maps acquired from the third pooling layer 60 as the first fully connected information to the second fully connected layer 64A.

The second fully connected layer 64A generates the human body feature information from the first fully connected information. The second fully connected layer 64A outputs the generated human body feature information together with the acquired first fully connected information to the first output layer 66A and the third fully connected layer 68A.

The first output layer 66A acquires the human body feature information. The first output layer 66A outputs the acquired human body feature information to the first time series NN unit 72 of the second half unit 42.

The third fully connected layer 68A generates the behavior recognition information from the first fully connected information. The third fully connected layer 68A outputs the behavior recognition information to the second output layer 70A.

The second output layer 70A normalizes the behavior recognition information. The second output layer 70A outputs the normalized behavior recognition information together with the human body feature information to the first time series NN unit 72 of the second half unit 42.

The functions, connection relationships, number, placement, and so on of the configurations of the embodiments described above may be appropriately changed, deleted, or the like within a scope of the embodiments disclosed here and a scope equivalent to the scope of the embodiments disclosed here. The respective embodiments may be appropriately combined together. The order of the steps of each embodiment may be appropriately changed.

In the embodiments described above, the image processing device 12 having three sets of the convolutional layers 50, 54, and 58 and the pooling layers 52, 56, and 60 has been exemplified, but the number of sets of the convolutional layers and the pooling layers may be appropriately changed. For example, the number of sets of the convolutional layers and the pooling layers may be one or more.

In the embodiments described above, the example in which two time series NN units 72 and 74 are provided has been described. However, the number of time series NN units may be appropriately changed. For example, the number of time series NN units may be one or more.

In the embodiments described above, the recurrent neural network having the GRU is referred to as an example of the time series NN units 72 and 74. However, the configuration of the time series NN units 72 and 74 may be changed as appropriate. For example, the time series NN units 72 and 74 may be recurrent neural networks having an LSTM (long short-term memory) or the like.

In the embodiments described above, the example in which the first fully connected information is the human body feature information has been described. However, the first fully connected information is not limited to the above configuration, as long as the information is the information in which the feature maps are connected.

In the embodiments described above, the image processing device 12 mounted on the automobile for recognizing or predicting the behavior of the occupant has been exemplified, but the image processing device 12 is not limited to the above configuration. For example, the image processing device 12 may recognize or predict the behavior of an outdoor person or the like.

An image processing device according to an aspect of this disclosure includes: an extraction unit that performs a convolution processing and a pooling processing on information of an input image including an image of a person and extracts a feature from the input image to generate a plurality of feature maps; a first fully connected layer that outputs first fully connected information generated by connecting the plurality of feature maps; a second fully connected layer that connects the first fully connected information and outputs human body feature information indicating a predetermined feature of the person; and a third fully connected layer that connects the first fully connected information or the human body feature information to output behavior recognition information indicating a probability distribution of a plurality of predetermined behavior recognition labels.

As described above, in the image processing device according to the aspect of this disclosure, since the human body feature information on the feature of the human and the behavior recognition information on the behavior of the person are generated from the first fully connected information generated by the first fully connected layer, two types of information with a different quality outputtable from less information can be output.

In the image processing device according to the aspect of this disclosure, the first fully connected layer may output the first fully connected information to each of the second fully connected layer and the third fully connected layer.

As described above, in the image processing device according to the aspect of disclosure, since the human body feature information and the behavior recognition information are generated according to the same first fully connected information output to each of the second fully connected layer and the third fully connected layer by the first fully connected layer, the types of outputtable information can be increased while reducing a complication of the configuration.

The image processing device according to the aspect of this disclosure may further include a second half unit that generates behavior prediction information on a future behavior of the person from a plurality of pieces of human body feature information and a plurality of pieces of behavior recognition information different in time.

As a result, the image processing device according to the aspect of this disclosure can generate the behavior prediction information on the future behavior of the person together with the human body feature information and the behavior recognition information according to the image by a configuration of an architecture or the like which is installed in one device.

In the image processing device according to the aspect of this disclosure, the second half unit may generate a probability distribution of a plurality of predetermined behavior prediction labels as the behavior prediction information.

As a result, the image processing device according to the aspect of this disclosure can predict and generate a probability of the multiple potential behaviors of the person.

In the image processing device according to the aspect of this disclosure, the second half unit may select and output the behavior prediction label highest in probability from the behavior prediction information.

As a result, the image processing device according to the aspect of this disclosure can narrow down the future behaviors of the person to one behavior, thereby being capable of reducing a processing load of an output destination device.

In the image processing device according to the aspect of this disclosure, the first fully connected layer may output the human body feature information indicating a predetermined feature of the person as the first fully connected information.

As a result, the second fully connected layer and the third fully connected layer reduce an influence of an environmental change or the like other than the person, thereby being capable of generating the human body feature information and the behavior recognition information high in precision.

A program according to another aspect of this disclosure causes a computer to function as an extraction unit that performs a convolution processing and a pooling processing on information of an input image including an image of a person and extracts a feature from the input image to generate a plurality of feature maps; a first fully connected layer that outputs first fully connected information generated by connecting the plurality of feature maps; a second fully connected layer that connects the first fully connected information and outputs human body feature information indicating a predetermined feature of the person; and a third fully connected layer that connects the first fully connected information or the human body feature information to output behavior recognition information indicating a probability distribution of a plurality of predetermined behavior recognition labels.

As described above, in the program according to the aspect of this disclosure, since the human body feature information on the feature of the human and the behavior recognition information on the behavior of the person are generated from the first fully connected information generated by the first fully connected layer, two types of information with a different quality outputtable from less information can be output.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An image processing device comprising:
an extraction unit that performs a convolution processing and a pooling processing on information of an input image including an image of a person and extracts a feature from the input image to generate a plurality of feature maps;
a first fully connected layer that outputs first fully connected information generated by connecting the plurality of feature maps;
a second fully connected layer that connects the first fully connected information and outputs human body feature information indicating a predetermined feature of the person; and
a third fully connected layer that connects the first fully connected information or the human body feature information to output behavior recognition information indicating a probability distribution of a plurality of predetermined behavior recognition labels.

2. The image processing device according to claim 1,
wherein the first fully connected layer outputs the first fully connected information to each of the second fully connected layer and the third fully connected layer.

3. The image processing device according to claim 1, further comprising a second half unit that generates behavior prediction information on a future behavior of the person from a plurality of pieces of the human body feature information and a plurality of pieces of the behavior recognition information different in time.

4. The image processing device according to claim 3,
wherein the second half unit generates a probability distribution of a plurality of predetermined behavior prediction labels as the behavior prediction information.

5. The image processing device according to claim 4,
wherein the second half unit selects and outputs the behavior prediction label highest in probability from the behavior prediction information.

6. The image processing device according to claim 1,
wherein the first fully connected layer outputs the human body feature information indicating a predetermined feature of the person as the first fully connected information.

7. A program that causes a computer to function as:
an extraction unit that performs a convolution processing and a pooling processing on information of an input image including an image of a person and extracts a feature from the input image to generate a plurality of feature maps;
a first fully connected layer that outputs first fully connected information generated by connecting the plurality of feature maps;
a second fully connected layer that connects the first fully connected information and outputs human body feature information indicating a predetermined feature of the person; and
a third fully connected layer that connects the first fully connected information or the human body feature information to output behavior recognition information indicating a probability distribution of a plurality of predetermined behavior recognition labels.
